(19) United States
(12) Patent Application Publication
(10) Pub. No.: US 2008/0308328 A1
(43) Pub. Date: Dec. 18, 2008

(54) Low cost conversion of any internal combustion vehicle into plug-in hybrid electric vehicle

(76) Inventor: Joseph B. Kejha, Meadowbrook, PA (US)

Correspondence Address: JOSEPH B. KEJHA, 1022 Frederick Rd., MEADOWBROOK, PA, 19046, US

(21) Appl. No.: 11/818,374

(22) Filed: Jun. 14, 2007

(51) Int. Cl. B60K 6/40; H02K 15/00

(52) U.S. Cl. 180/65.2; 29/732; 903/942; 903/951

(57) ABSTRACT

This invention pertains to an economical method of easy conversion of any internal combustion fueled vehicle into a fuel saving plug-in hybrid electric vehicle (PHEV) by an add-on kit, without replacing the engine and with a minimal modification of the vehicle body. The converted vehicle substantially saves fuel as compared to the vehicle before this conversion.

### CROSS REFERENCE TO RELATED DOCUMENTS

The subject matter of the invention is described in the Disclosure Document of Joseph B. Kejha Ser. No. 600,693 filed on May 12, 2006, and entitled “Low Cost Conversion of any Vehicle into a Plug-in Hybrid Electric Vehicle.”

### BACKGROUND OF THE INVENTION

1. Field of the Invention

This invention pertains to easy conversion of any existing vehicles with internal combustion-only engine into plug-in hybrid electric vehicles, without replacing the engine and with a minimal modification of the vehicle body, and thus substantially saving any fuel and reducing CO₂ emissions.

2. Description of the Prior Art

It is well known, that Plug-in Hybrid Electric Vehicle (PHEVs) are different from self-charging Hybrid Electric Vehicles (HEVs) by having additional batteries in parallel with a HEV battery, which additional batteries have to be recharged by plugging into electric grid and charging said extra batteries. The purpose of the Plug-in HEVs is to drive in electric-only mode for a certain limited distance, such as commuting to work, or driving in the near neighborhood, and thus saving more gasoline or other fuels than the self-charging HEVs, and conventional vehicles. For longer trips the internal combustion engine in combination with electric drive is used. Up to 80% of fuel can be thus saved, as compared to equivalent conventional vehicles, and all oil imports can be eliminated.

The existing self-charging HEVs can drive in electric-only mode at 35 MPH speed, 5 miles or less, due to the small battery. The “Plug-ins” can drive up to 40 miles, (depending on the battery size), which makes them practical for electric-only commuting.

Prior art Plug-in Hybrid Electric Vehicles (PHEVs) are made by modifying the existing HEVs by adding extra batteries and a charger into the trunk.

Due to the cost of vehicle fuels rising, there is a need to make fast as many Plug-in HEVs as possible.

The problem is that there is not enough of the existing HEVs made to the converted into the Plug-in HEVs (PHEVs), and thus substantially reduce oil consumption, cost and oil import. Making many new self-charging or plug-in HEVs takes long time and huge sums of money. The instant invention solved this problem, because by its add-on kit and its novel method of conversion, any existing internal combustion vehicle can be easily converted into a Plug-in Hybrid Electric Vehicle and thus substantially save fuel and cost, which is the primary object of this invention.

Prior art self-charging HEVs, including internal combustion vehicles converted into self-charging HEVs, and HEVs converted into PHEVs employ a sophisticated communication system of sensors and controls between the electric and the internal combustion engine drive systems (=energy management). This invention provides much simpler system by having two totally independent drives in one vehicle; one driven by fuel, and the other driven by electricity. The driver then decides and selects which one to use.

Prior art method of conversion of an internal combustion vehicle into a HEV or PHEV vehicle involves removing the existing drive system (including the engine) from the body of the vehicle and replace it with a new hybrid electric drive system having a smaller engine. This means virtually “gutting” and rebuilding the vehicle, including the body, which is impractical, time consuming and expensive.

This invention does not suffer from prior art problems and provides a simpler lower cost conversion method, which results in improved vehicle efficiency and large fuel savings, and has many other advantages.

### SUMMARY OF THE INVENTION

It has now been found, that any existing internal combustion (IC) vehicle can be easily converted at a relatively low cost into a plug-in hybrid electric vehicle (PHEV) by replacing at least one, or all of its preferably non-driven wheels with a least one new wheel(s) containing electric motor(s), which may be also refered to as “wheel-motor(s),” and by adding at least one electric energy storage unit(s), such as a battery or a battery with a capacitor or ultracapacitor into the trunk or a storage place of the vehicle, and electrically connecting them by wires and/or cables through at least one electric control unit(s), mounted in any desirable place in the vehicle, including in the electric motor(s). A charger with a cable and plug should be also added into the vehicle and electrically connected to the energy storage unit(s). The axles and suspension supporting the new wheel(s) with electric motor(s) may be preferably reinforced, or replaced with similar, stronger parts. The battery should be larger than the battery in the self-charging hybrid electric vehicle, and must be rechargeable by connecting it to the outside electric grid (out of the PHEVs) and should provide the electric-only driving range of 20-60 miles at highway speeds 60-70 MPH, (unlike today's HEVs). This is substantially less range than an advanced full electric-only vehicle, but is sufficient to drive as a zero emission vehicle to work, or around the town, and thus save hydrocarbon fuels, or to extend the range of the internal combustion drive system. The existing internal combustion (IC) engine and its drive system stay intact. The electric and the internal combustion system should work preferably completely independently from each other, without communication between there, and the electric drive may be put in use by a selection switch, and by putting the internal combustion transmission into neutral, and by disconnecting the ignition. (No other communications or controls are needed). This independent work of each system of this invention is the major difference from the HEV vehicles. The operator decides which system to use for the specific purpose of driving. For example, commuting to work with the electric-only drive, and for a long trip will use the engine drive-only. The electric control unit(s) should be connected to the existing accelerator pedal, and brake pedals (or any other control) of the vehicle, preferably without any additional operator's input(s) (command(s), so that the operator can drive the vehicle electrically, preferably the same way as any other conventional vehicle before this conversion.

The main purpose of the electric motor(s) in the wheel(s) is mostly to drive the vehicle in electric-only mode, and also they may assist brakes during breaking and absorb-fully or partly the deceleration energy of the vehicle and regenerate (recharge) thus the battery. Additionally, the electric motor(s) may help (assist) the internal combustion engine during heavy duty use, such as during an off-road driving, hill climbing and in the snow, on command only by the operator, equivalent to 4-wheel drive. During braking, the electric motor(s) in the wheels may become generator(s), since they may have both functions by design and are driven by the inertia of the vehicle through the friction with the road. If two or more motor(s) are used, then their controls must compensate for their different RPM during turns of the vehicle. This conversion should be custom designed to fit the selected vehicle as an add-on kit, or added-on option to new vehicles by their manufacturers. The kits should also include an installation of electric/hydraulic pump for hydraulic brakes and power steering, electric heater, defrosters, and the original low volt vehicle battery charging from the PHEV battery.

Advantages of this PHEV conversion are: 1. Much simpler system than the system in prior art HEVs and PHEVs. 2. Four wheel (or more) drive in the snow, etc. 3. Easy engine start in cold weather, if low temperature operation ultracapacitors are used in the electric energy storage unit(s). 4. Vehicle also may start to drive in electric-only mode, and then by the vehicle inertia—crank the internal combustion engine to start.

The principal object of this invention is to provide low cost and easy conversion of any internal combustion vehicle and into Plug-in Hybrid Electric Vehicle and thus save fuel.

Another object of this invention is to provide vehicles, which lower CO2 emissions and eliminate oil imports.

Other objects and advantages of the invention will be apparent from the description and claims.

### BRIEF DESCRIPTION OF THE DRAWING

The nature and characteristic features of the invention will be more readily understood from the following description taken in connection with the accompanying drawing forming part hereof in which:

FIG. 1 is a diagrammatic, side elevational view of the front wheel drive vehicle, illustrating its components and preferred locations of the added electric drive components.

FIG. 2 is a diagrammatic, top elevational, sectional view of the vehicle at the line 2-2 of FIG. 1, illustrating location of its components, including the electric drive system.

FIG. 3 is a diagrammatic, side elevational view of the rear wheels drive vehicle, illustrating its components and preferred locations of the added electric drive components.

FIG. 4 is a diagrammatic, top elevational, sectional view of the vehicle at the line 4-4 of FIG. 3, illustrating location of its components, including the electric drive system.

FIG. 5 is a diagrammatic, side elevational view of the front wheel drive vehicle, illustrating its components and electric wheel-motor(s) mounted to driven axle(s) by the engine.

FIG. 6 is a diagrammatic, side elevational view of two-wheeled vehicle, illustrating its components and preferred locations of its electric drive system.

Like numerals refer to like parts throughout the several views and figures.

It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Fuel saving hybrid electric vehicles (HEV's) employ propulsion system comprising a smaller internal combustion engine mechanically connected to an electric motor/generator, which is electrically connected to a battery through a control unit with sensors. This usually requires designing and building the vehicles “from scratch”, or requires an extensive modification and rebuilding of the existing vehicles. Both methods are time consuming and expensive. The HEVs are then converted into plug-in HEVs by adding a larger battery with a charger. The present invention employs a novel method of easy conversion of any internal combustion-only vehicle into plug-in hybrid electric vehicle (PHEV), which is fast, simple and low cost, and thus it can accelerate our effort to be free from the imported oil.

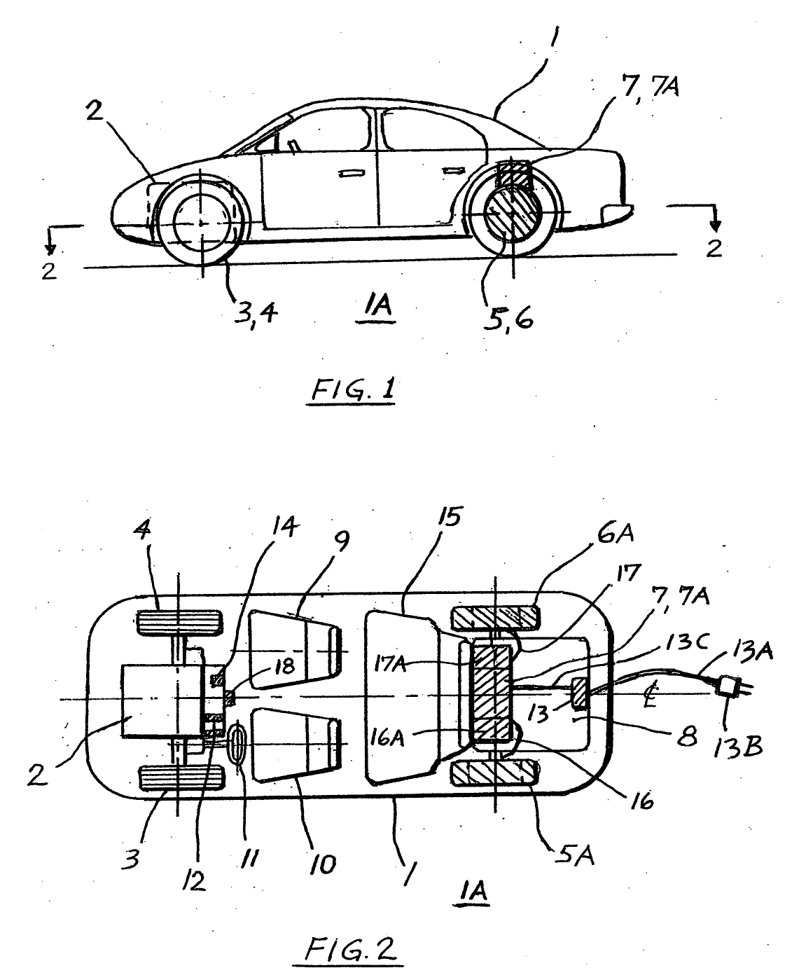

The invention will be better understood when referring in more detail to the drawings of this patent and FIGS. 1 and 2, which is one embodiment of this invention illustrating as an example vehicle 1A, comprising body 1 with a large standard internal combustion engine 2 driving front wheels 3 and 4, which wheels are steered by steering system 11, and the vehicle includes passenger seats 9, 10 and 15 and trunk 8 and rear non-driven wheels 5A and 6A, which wheels are replaced during the conversion with wheels having electric motors 5 and 6 therein. At least one wheel may be replaced in this manner. Additionally, electric energy storage units 7 such as a battery, and optionally ultracapacitor 7A in parallel are added into the trunk 8, and are connected with the electric motors 5 and 6 via cables 16 and 17, through electric control units 16A and 17A. At least one electric energy storage unit is necessary and preferably the battery. The units 16A and 17A are electrically connected to command potentiometer 12 attached to gas pedal of the engine 2 by a well known link and lever (not shown). Additionally, at least one electric charger 13 with cable 13A and plug 13B are added into the trunk 8, and the charger 13 is electrically connected to the battery 7 by cable 13C. The charger 13 can be then connected to electric grid via plug 13B. The cells of the battery 7 may be charged in parallel, as described in my prior U.S. Pat. No. 5,811,959. Only a small modification of the vehicle body by adding holes for the connecting cables and wires may be necessary. The energy storage unit(s) 7 and 7A may be located in any desirable and available place in the vehicle, but the trunk space behind the rear seats is preferred. The ultracapacitor 7A provides for long cycle life of the battery 7, due to absorbing high electric peak loads. For example, a front wheel engine driven vehicle 1A has the electric motors 5 and 6 in the rear wheels, and the energy storage unit, such as a large lithium-ion battery 7 for approximately 40 miles electric-only range with an ultracapacitor 7A are in the trunk above the electric wheel-motors 5 and 6, which helps to compensate as a counter-weight against the “unsprung weight” of these wheel-motors, resulting thus in a smoother ride. The axles and suspension supporting the new wheel(s) with the electric motors should be preferably reinforced or replaced with similar, stronger parts. The engine 2 is not replaced with a smaller engine.

The control unit(s) 16A and 17A are commanded by the accelerator pedal (or any other controls) of the vehicle, preferably without any additional operator's input, so that the operator can drive the vehicle preferably the same way as any other conventional vehicle before this conversion.

The purpose of the electric wheel-motors 5 and 6 is to drive the vehicle in electric-only mode for relatively short trips, such as commuting to work at highway speeds, or around the neighborhood slowly. This lowers the consumption of gasoline or any other fuel up to 80% and extends the driving range of the vehicle. During the electric-only driving, the engine 2 is disconnected from the front wheels 3 and 4 and should not be operating. Engine transmission should be in “neutral” position and the engine disconnect and shut-off may be done automatically by a selection switch 14 with interlock, which switch will also put the vehicle into electric-drive mode. Electric-reverse should be done by another switch 18. No communications or controls are needed between the internal combustion (IC) engine 2 and the electric drive system. This independent work of each system makes the vehicle controls very simple and low cost. During braking, the electric motors 5 and 6 may become generators by design, to assist the brakes and absorb partly or fully the energy of braking, and store the energy in the energy storage units 7 and 7A, to be ready for use for the next acceleration and driving of the vehicle. During braking, the electric motors in the wheels may become electric generators, since they may have both functions by design and are driven by the inertia of the vehicle. When the energy storage is full, it is disconnected from charge; by control unit(s) 16A and 17A. The electric motors 5 and 6 may also have an overdrive clutch to reduce the friction. In this case, the motors will not be also generators. Control units 16A and 17A also compensate for different RPM of the wheels 5 and 6 during turns of the vehicle, similarly as the differential gear box of engine driven wheels. The control units may be also included in the wheel-motor(s), instead being with the energy storage units. This provides for more trunk space. The internal combustion (IC) engine 2 is used for longer trips, preferably without the electric drive assistance. The operator decides and selects which drive system to use for specific purpose. Additionally, both systems together may be used for a heavy duty driving. For this, the selector switch 14 may have another position and will “unlock” the engine 2. The vehicle 1A also can not get “stuck” with a discharged battery 7 and can continue driving by using the engine 2. The described conversion components should be custom designed to fit selected vehicle as a kit or as an added-on option to new vehicles by their manufacturers.

The kits should also include an installation of electric/hydraulic pump for power brakes and power steering, electric heater, defrosters and low volt charging the engine start battery from the battery 7.

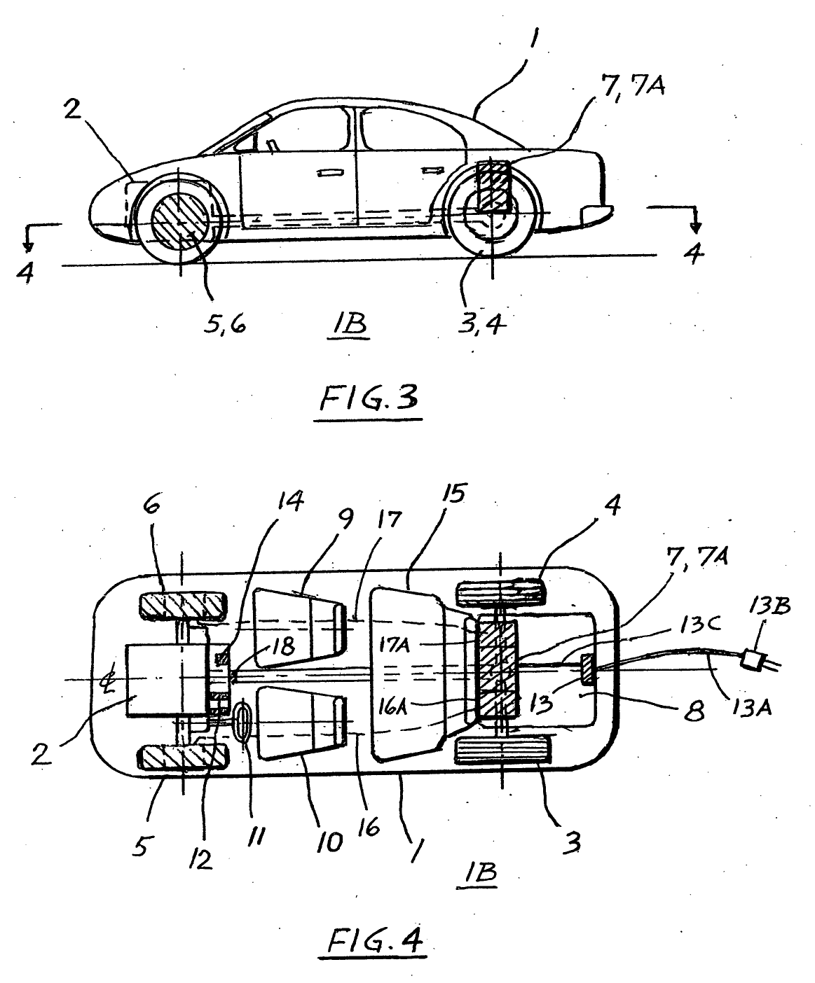

If a vehicle has rear wheels driven by the engine, such as vehicle 1B shown in FIGS. 3 and 4, then the electric wheel-motors 5 and 6 may replace the front non-driven wheels, which is another embodiment of the invention. At least one wheel may be replaced in this manner. If a vehicle has four or more driven wheels by the engine, then at least one wheel may have its drive axel(s) disconnected and the wheel(s) replaced with the electric wheel-motors (not shown). Similarly, a three-wheeled vehicle's non-driven wheel(s) can be replaced with the electric wheel-motors (not shown).

At least one electric wheel-motor 5 or 6 may also replace at least one driven wheel by the engine of the vehicle 1C, as shown in FIG. 5 as an example, which is another embodiment of the invention. Consequently, all or any wheel(s) of a vehicle (driven and/or non-driven by the engine) may be replaced with electric wheel-motor(s) (not shown). Then, in the electric mode, the engine may be disconnected by the clutch, put into neutral and shut-off.

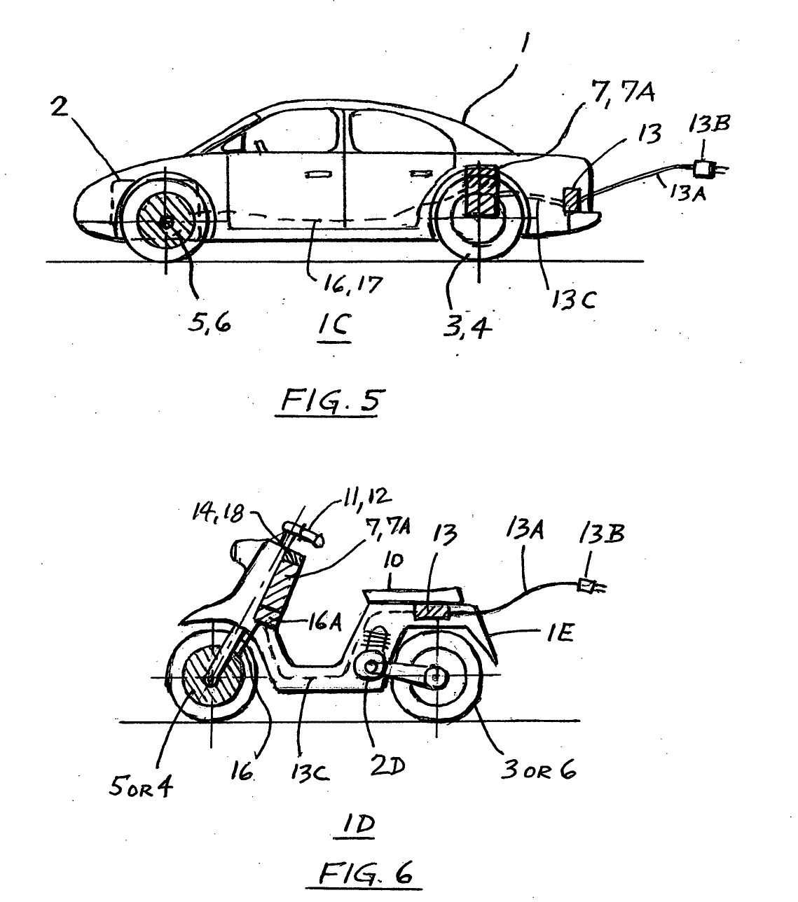

Similarly, another embodiment of the invention is two wheeled vehicle 1D, having body 1E with engine 2D, as shown in FIG. 6. The vehicle 1D has at least one wheel replaced with electric wheel-motor(s) 5 and/or 6, and has electric energy storage unit(s) 7, 7A with charger 13 added, and electrically connected as shown.

It is apparent to any person skilled in the art, that the described conversion methods and kits can convert any internal combustion vehicle into a plug-in hybrid electric vehicle, and thus save up to 80% of fuel, which could eliminate all oil imports.

It should, of course, be understood that the description and the drawings herein are merely illustrative and it will be apparent that various modifications, combinations and changes can be made of the structures and systems disclosed without departing from the spirit of the invention and from the scope of the appended claims.

It will thus be seen, that a more economical and reliable conversion method of any internal combustion vehicle into plug-in hybrid electric vehicle (PHEV) has been provided, with which the objects of the invention are achieved.

I claim:

1. A method of conversion of internal combustion-only vehicle into a fuel saving plug-in hybrid electric vehicle, comprising the steps of:
providing a steerable front wheel(s) driven internal fuel combustion vehicle, which vehicle includes an engine with an ignition system, a storage space and non-driven rear wheel(s),
providing at least one electric wheel-motor,
replacing said rear non-driven wheel(s) of said vehicle with said electric wheel-motor(s),
providing at least one electric energy storage unit,
placing and mounting said electric energy storage unit(s) into said storage space,
providing at least one electric control unit for said electric wheel-motor(s),
placing and mounting said electric control unit(s) into said storage space,
electrically connecting said electric storage unit(s) with said electric wheel-motor(s) via said electric control unit(s),
providing at least one electric charger which is a electrically connectable to electric grid out of said vehicle,
placing and mounting said charger into said vehicle and electrically connecting said charger to said electric storage unit(s),
providing vehicle operator's electric command controls,
placing and mounting said command controls into said vehicle, and electrically connecting said command controls with said electric control unit(s),
charging said electric energy control unit(s) by said charger(s),
and driving said vehicle in electric mode with said engine shut-off and disconnected, or in engine mode with said electric drive shut-off.

2. A method of conversion of internal combustion-only vehicle into a fuel saving plug-in hybrid electric vehicle, comprising the steps of:
providing a steerable, rear wheel(s) driven internal fuel combustion vehicle, which vehicle includes an engine with an ignition system and a fuel, a storage space, and non-driven front wheel(s),
providing at least one electric wheel-motor,
replacing said front non-driven wheel(s) of said vehicle with said electric wheel-motor(s),
providing at least one electric energy storage unit,
placing and mounting said electric energy storage unit(s) into said storage space,
providing at least one electric control unit for said electric wheel-motor(s),
placing and mounting said electric control unit(s) into storage space,
electrically connecting said electric storage unit(s) with said electric wheel-motor(s) via said electric control unit(s),
providing at least one electric charger which is electrically connectable to electric grid out of said vehicle,
placing and mounting said charger(s) into said vehicle and electrically connecting said charger(s) to said electric storage unit(s),
providing vehicle operator's electric command controls,
placing and mounting said command controls into said vehicle, and electrically connecting said command controls with said electric control unit(s),
charging said electric energy storage unit(s) by said charger(s),
and driving said vehicle in electric mode with said engine shut-off and disconnected, or in engine mode with said electric drive shut off.

3. A method of conversion of internal combustion-only vehicle into a fuel saving plug-in hybrid electric vehicles, comprising the steps of:
providing a steerable all wheels driven internal fuel combustion vehicle, which vehicle includes an engine with an ignition system and a fuel, and a storage space,
disconnecting said drive to at least one wheel,
providing at least one electric wheel-motor,
replacing said drive disconnected wheel(s) of said vehicle with said electric wheel-motor(s),
providing at least one electric energy storage unit,
placing and mounting said electric energy storage unit(s) into said storage space,
providing at least one electric control unit for said electric wheel-motor(s),
placing and mounting said electric control unit(s) into said storage space,
electrically connecting said electric storage unit(s) with said electric wheel-motor(s) unit(s) via said electric control unit(s),
providing at least one electric charger which is electrically connectable to electric grid out of said vehicle,
placing and mounting said charger into said vehicle and electrically connecting said charger to said electric storage unit(s),
providing vehicle operator's electric command controls,
mounting said command controls into said vehicle, and electrically connecting said command controls with said electric control unit(s),
charging said electric energy storage unit(s) by said charger(s),
and driving said vehicle in electric mode with said engine shut-off and disconnected, or in engine mode with electric drive shut-off.

4. A method of conversion of internal combustion-only vehicle into a fuel saving plug-in hybrid electric vehicle comprising the steps of:
providing a steerable front wheel driven internal fuel combustion vehicle, which vehicle includes an engine with an ignition system and a fuel, a storage space, and non-driven rear wheel(s),
providing at least one electric wheel-motor,
replacing said front driven wheel(s) with said electric wheel-motor(s),
providing at least one electric energy storage unit,
placing and mounting said electric energy storage unit(s) into said storage space,
providing at least one electric control unit for said electric wheel-motor(s),
placing and mounting said electric storage unit(s) into said storage space,
electrically connecting said electric storage unit(s) with said electric wheel-motor(s) via said electric control unit(s),
providing at least one electric charger which is electrically connectable to electric grid, out of said vehicle,
placing and mounting said charger(s) into said vehicle and electrically connecting said charger(s) to said electric storage unit(s),
providing vehicle operator's electric command controls,
placing and mounting said command controls into said vehicle, and electrically connecting said command controls with said electric control unit(s),
charging said electric energy storage unit(s) by said charger(s),
and driving said vehicle in electric mode with said engine shut-off and disconnected, or in engine mode with said electric drive shut-off,

5. A method of conversion of internal combustion-only vehicle into fuel saving plug-in hybrid electric vehicle comprising the steps of:
providing a steerable, rear wheel(s) driven internal fuel combustion vehicle, which vehicle includes an engine with an ignition system and a fuel, a storage space, and non-driven front wheel(s),
providing at least one electric wheel motor,
replacing said rear driven wheel(s) of said vehicle with said electric wheel-motor(s),
providing at least one electric energy storage unit,
placing and mounting said electric energy storage unit(s) into said storage space,
providing at least one electric control unit for said electric wheel-motor(s),
placing and mounting said electric control unit(s) into said storage space,
electrically connecting said electric storage unit(s) with said electric wheel-motor(s) via said electric control unit(s),
providing at least one electric charger which is electrically connectable to electric grid, out of said vehicle,
placing and mounting said charger into said vehicle and electrically connecting said charger to said electric storage unit(s),
providing vehicle operator's electric command controls,
placing and mounting said command controls into said vehicle,
and electrically connecting said command controls with said electric control unit(s),
charging said electric energy storage unit(s) by said charger(s),
and driving said vehicle in electric mode, with said engine shut-off and disconnected, or in engine mode with said electric drive shut-off.

6. A method of conversion of internal combustion vehicle into a fuel saving plug-in hybrid electric vehicle comprising the steps of:
providing a steerable all wheels driven internal fuel combustion vehicle, which vehicle includes an engine with an ignition system and a fuel, and a storage space, providing at least one electric wheel-motor,
replacing at least one driven wheel(s) of said vehicle with said electric wheel-motor(s),
providing at least one electric energy storage unit,
placing and mounting said electric energy storage unit(s) into said storage space,
providing at least one electric control unit for said electric wheel-motor(s),
placing and mounting said control unit(s) into said storage space,
electrically connecting said electric control unit(s) with said electric wheel-motor/generator(s) unit(s) via said electric control unit(s),
providing at least one electric charger which is electrically connectable to electric grid out of said vehicle,
placing and mounting said charger into said vehicle and electrically connecting said charger to said electric storage unit(s),
providing vehicle operator's electric command controls,
placing and mounting said command controls into said vehicle, and electrically connecting said command controls with said electric control unit(s),
charging said electric energy storage unit(s) by said charger(s),
and driving said vehicle in electric mode, with said engine shut-off and disconnected, or in engine mode with said electric drive shut-off.

7. A method of conversion of internal combustion-only vehicle into a fuel saving plug-in hybrid electric vehicle, as described in claim 1, or 2, or 3, or 4, or 5, or 6, in which said electric control units are included in said electric wheel-motor(s).

8. A method of conversion of internal combustion-only vehicle into a fuel saving plug-in hybrid electric vehicle, as described in claim 1, or 2, or 3, or 4, or 5, or 6, in which said electric control units compensate for driving different revolutions per minute of said wheel-motor(s) during turns of the vehicle.

9. A method of conversion of internal combustion-only vehicle into a fuel saving plug-in hybrid electric vehicles, as described in claim 1, or 2, or 3, or 4, or 5, or 6, in which said electric energy storage unit(s) comprise a battery and ultracapacitor.

10. A method of conversion of internal combustion-only vehicle into a fuel saving plug-in hybrid electric vehicle, as described in claim 1, or 2, or 3, or 4, or 5, or 6, in which said electric energy storage unit is a battery.

11. A method of conversion of internal combustion-only vehicle into a fuel saving plug-in hybrid electric vehicle, as described in claim 1, or 2, or 3, or 4, or 5, or 6, in which axle(s) and suspension of said electric wheel-motor(s) is (are) reinforced.

12. A method of conversion of internal combustion-only vehicle into a fuel saving plug-in hybrid electric vehicle, as described in claim 1, or 2, or 3, or 4, or 5, or 6, which method additionally includes an installation of component(s) selected from the group comprising: an electric/hydraulic pump for existing power brakes and power steering; an electric heater for heating the air inside of said vehicle;
a low volt connecting means for charging the existing low volt vehicle battery from said electric energy storage unit(s); and a fuel gauge of said electric energy storage unit(s) with its mounting and connecting means.

13. A conversion kit for converting selected internal combustion-only engine vehicle into a fuel saving plug-in hybrid electric vehicle comprising:
at least one electric wheel-motor with its mounting and connecting means;
at least one electric energy storage unit with its mounting and connecting means;
at least one electric control unit of said wheel-motor(s) with its mounting and connecting means;
at least two operator's electric command controls, which include an accelerator and selector/power switch, with their mounting and connecting means;
at least one electric charger for said energy storage unit(s), with its mounting and connecting means to electric grid out of said vehicle and to said energy storage unit(s), and
said kit is custom designed to fit said selected vehicle, and said electric wheel-motor(s) replace(s) at least one wheel of said internal combustion-only engine vehicle, and said described components are mounted into said vehicle to be driven in electric mode with said engine shut-off and disconnected, or in engine mode with said electric drive disconnected.

14. A conversion kit for converting internal combustion-only engine vehicle into a fuel saving plug-in hybrid electric vehicle as described in claim 13, which kit additionally includes component(s) selected from the group comprising:
an electric/hydraulic pump for existing power steering and power brakes;
an electric heater for heating the air inside of said vehicle; low volt connecting means for charging the existing low volt vehicle battery from said energy storage unit(s); and a fuel gage of said electric energy storage unit(s) with its mounting and connecting means.
